(19) United States
(12) Patent Application Publication
(10) Pub. No.: US 2020/0001312 A1
(43) Pub. Date: Jan. 2, 2020

(54) RECIPROCATING PLUNGER PUMP FOR SPRAY COATER

(71) Applicant: Zhejiang Rongpen Air Tools Co., Ltd., Taizhou (CN)

(72) Inventors: Zhenxing Yin, Taizhou (CN); Jiangguo Liu, Taizhou (CN); Bo Chen, Taizhou (CN); Junpeng Wei, Taizhou (CN); Fazheng Yang, Taizhou (CN); Xiaorong Li, Taizhou (CN)

(73) Assignee: Zhejiang Rongpen Air Tools Co., Ltd.

(21) Appl. No.: 16/145,082

(22) Filed: Sep. 27, 2018

(30) Foreign Application Priority Data
Jun. 30, 2018 (CN) 201810701867.8

(51) Int. Cl. B05B 9/04; F04B 19/22; F04B 53/16

(52) U.S. Cl. CPC B05B 9/0413; F04B 19/22; F05B 2260/30; F05B 2240/14; F04B 53/16

(57) ABSTRACT

A reciprocating plunger pump for spray coater which is capable of being assembled and disassembled quickly comprises a housing, a piston located in the housing and a plunger pump assembly connected to the piston. A mounting groove is located in the housing. The bottom of the mounting groove is provided with a holding opening through to it. The holding opening and the mounting groove opening are intersecting and interpenetrating. The inner wall of the mounting groove is provided with a U-shaped chucking step. One end of the piston is located in the mounting groove and provided with a connecting slot, the connecting slot is T-shaped. One side of the connecting slot is provided with an opening. The plunger pump assembly is provided with a piston rod. The end of the piston rod is I-shaped.

### BACKGROUND OF INVENTION

### 1. Field of the Invention

The present invention relates generally to a reciprocating plunger pump for spray coater, and more particularly to a reciprocating plunger pump for spray coaters which is capable of being assembled and disassembled quickly.

### 2. Description of Related Art

The spray coater is a device for high pressure spray coating. The high pressure spray coating is extensively used for such spray coating operations as home decoration emulsion paint spray coating, water proofing, anticorrosion and steel structure anticorrosion spray coating, the working efficiency is increased greatly, and the workers' labor intensity is reduced.

The core component for generating the pressure of spray coater is the plunger pump. In high intensity operation, the core components of plunger pump are wearing parts, so the components are usually repaired or changed.

However, the housing of conventional plunger pump is screwed to the plunger pump assembly through the bolt holes in the housing, and the plunger pump assembly is heavy, the plunger pump assembly cannot be mounted and fixed only by hand. Therefore, there are notchs located on both sides of the outer wall of plunger pump for the spanner to clamp, so that the plunger pump assembly can be pulled by the spanner. As external tools are involved, it is inconvenient to assemble and disassemble the plunger pump. It will not be assembled/disassembled without the required external tool, so that the equipment maintenance and replacement efficiency is low.

### SUMMARY OF THE INVENTION

The technical problem to be solved by the present invention is to overcome the deficiencies of the prior art and to provide a reciprocating plunger pump for spray coater.

In order to solve the above technical problems, the present invention adopts the following technical solutions:

A reciprocating plunger pump for spray coaters which is capable of assembled and disassembled quickly comprising: a housing, a piston located in a housing and a plunger pump assembly connected to the piston; wherein the housing includes a mounting groove disposed therein, a holding opening disposed at a bottom of the mounting groove and communicated with the mounting groove; an inner wall of the mounting groove has a U-shaped latching step; one end of the piston is located in the mounting groove and provided with a connecting slot, and the connecting slot is T-shaped; one side of the connecting slot has an opening; the plunger pump assembly is provided with a piston rod; one end of the piston rod is I-shaped; the end of piston rod is inserted into the connecting slot through the opening; an upper part of the plunger pump assembly is sleeved with a disassembly sleeve; and a middle part of the disassembly sleeve includes an annular groove matching the latching step; the annular groove forms an upper seizing part clinging to an upper surface of latching step and a lower seizing part clinging to the lower surface of latching step in upper and lower parts of disassembly sleeve; an opening of the mounting groove is covered with a fixing side cover; one side of the fixing side cover opposite to the disassembly sleeve is provided with a pressing block matched with the disassembly sleeve; the fixing side cover fixes the plunger pump assembly into the mounting groove by fixing devices.

More particularly, wherein the pressing block has an arch bridge shape, the pressing block is provided with a semicircular indent, a bottom of the indent is provided with an auxiliary groove in the shape of an arch bridge.

More particularly, wherein the fixing side cover is provided with symmetrical punch holes on both sides; one side of the housing opposite to the fixing side cover is provided with bolt holes corresponding to the punch holes; the fixing devices are butterfly screws, the butterfly screws penetrate through the punch holes and are screwed in the bolt holes; the fixing side cover is fastened to the housing by butterfly screws.

More particularly, wherein a top of the butterfly screw includes mutually symmetrical connecting holes.

More particularly, wherein the fixing devices include a rotating shaft hinged on both sides of a bottom of the housing; the rotating shaft is connected to a pull plate; one end of the pull plate is provided with a holding portion; the holding portion is connected with a hook through the connecting rod; the fixing side cover is provided with a caulking groove matched with the hook.

More particularly, wherein an outer surface of the holding portion includes a plurality of non-slip bulges uniformly distributed.

More particularly, wherein the both sides of the bottom of the housing include mutually symmetrical through holes; the fixing side cover has limiting holes corresponding to the through holes; the fixing devices include the limiting pin in the through hole; one end of the limiting pin passes through the limiting hole and is provided with a limiting head matched with the fixed side cover, and the other end passes through the through hole and is provided with an annular limiting groove; the housing is hinged with a U-shaped positioning rod; the positioning rod is provided with a matching fork matched with the limiting slot; the housing is screwed with an L-shaped bolt corresponding to a free end of the positioning rod.

More particularly, wherein the housing includes a hinge hole; one end of the positioning rod passes through the hinge hole and is provided with an annular positioning groove; the positioning groove is mounted with a matching circlip.

More particularly, wherein a side of the latching fork opposite to the limiting slot is provided with a U-shaped notch; the limiting pin forms a pressing end through the limiting slot; one side of the locking fork opposite to the limiting groove is provided with a U-shaped notch; the limiting groove forms a pressing end of the limiting pin; the side of the locking fork that is contacting with the pressing end is an inclined plane.

Compared to the prior arts, the above-mentioned housing can get the plunger pump assembly stuck in the mounting groove directly through the opening of mounting groove, and the holding opening enables the plunger pump assembly to move into the mounting groove smoothly from side.

When the plunger pump assembly is being chucked in the mounting groove, the chucking step penetrates into the annular groove directly, the upper seizing part and lower seizing part confine the up-down movement of plunger pump assembly effectively, and the end of piston rod is stuck in the connecting slot of piston. The clamping of the end of piston rod and connecting slot and the clamping of chucking step and annular groove form two longitudinal fixings, so that the plunger pump assembly will never have longitudinal displacement. As long as the fixing side cover confines the lateral movement of plunger pump assembly, the plunger pump assembly and housing 1 and be fixed. The fixing side cover is fixed by fixing devices, the fixing devices can be fixed by hand easily. Therefore, the worker can assemble and disassemble the plunger pump assembly and housing easily, the equipment maintenance and replacement efficiency is increased effectively.

### BRIEF DESCRIPTION OF THE DRAWINGS

FIG. 1 is a perspective view of embodiment 1 of a housing;

FIG. 2 is a perspective view of embodiment 2 of the housing;

FIG. 3 is a perspective view of embodiment 2 of the housing;

FIG. 4 is an enlarged view of Part A of FIG. 3;

FIG. 5 is a perspective view of embodiment 3 of the housing;

FIG. 6 is a perspective view from an angle of embodiment 3 of the housing;

FIG. 7 is a perspective view from another angle of embodiment 3 of the housing.

### DETAILED DESCRIPTION OF THE INVENTION

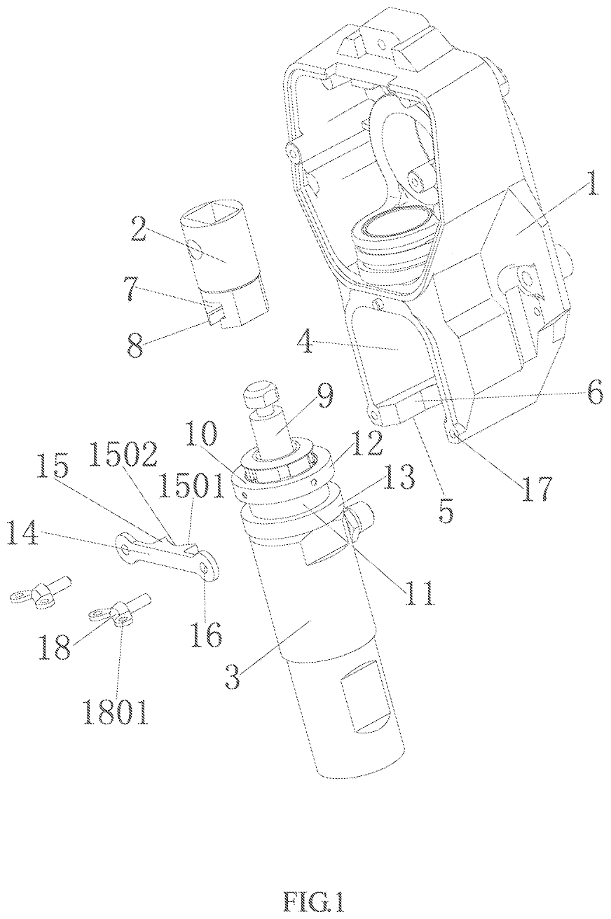

Embodiment 1, as shown in FIG. 1, a reciprocating plunger pump for spray coaters which can be assembled and disassembled quickly comprises a housing 1, a piston 2 located in housing 1 and a plunger pump assembly 3 connected to piston 2. A mounting groove 4 is located in the housing 1. The bottom of the mounting groove 4 is provided with a holding opening 5 through to it. The holding opening 5 and the opening of mounting groove 4 are intersecting and interpenetrating. A U-shaped chucking step 6 is located in the inner wall of the mounting groove 4. One end of the piston 2 is located in mounting groove 4 and provided with a connecting slot 7. The connecting slot 7 is T-shaped. One side of the connecting slot 7 is provided with an opening 8. The plunger pump assembly 3 is provided with a piston rod 9. The end of the piston rod 9 is I-shaped. The end of piston rod 9 is chucked in the connecting slot 7 through the opening. An disassembly sleeve 10 is fitted over the upper part of the plunger pump assembly 3. An annular groove 11 matching the chucking step 6 is located in the middle of the disassembly sleeve 10. The annular groove 11 forms the upper seizing part 12 clinging to the upper surface of chucking step 6 and the lower seizing part 13 clinging to the lower surface of chucking step 6 in the upper and lower parts of disassembly sleeve 10. The opening of the mounting groove 4 is covered with a fixing side cover 14. One side of the fixing side cover 14 opposite to the disassembly sleeve 10 is provided with a pressing block 15 matching the disassembly sleeve 10. The fixing side cover 14 fixes the plunger pump assembly 3 into the mounting groove 4 by fixing devices.

The pressing block 15 is like an arch bridge. The pressing block 15 is provided with a semicircular indent 1501, an arch bridge-like auxiliary groove 1502 is located in the bottom of indent 1501. Therefore, the pressing block is similar to an encloser, confining the truncated cone-like disassembly sleeve through indent 1501 easily, the contact surface between the pressing block and the disassembly sleeve is enlarged to the maximum extent, so as to enhance the firmness. The auxiliary groove 1502 avoids the interference of burrs and solid particles in the replacement failing compaction effectively. The arch face of auxiliary groove 1502 forms elastic force pressing inwards during compaction, the compaction is more effective.

Mutually symmetrical punch holes 16 are located in both sides of the fixing side cover 14. One side of the housing 1 opposite to the fixing side cover 14 is provided with bolt holes 17 corresponding to punch holes 16. The fixing devices are butterfly screws 18. The butterfly screws 18 penetrate through the punch holes 16 and are screwed in bolt holes 17. The fixing side cover is fastened on the housing 1 by butterfly screws 18.

Mutually symmetrical connecting holes 1801 are located in both sides of the head of the butterfly screw 18. The connecting holes 1801 can be bound with a cord, and the free end of the cord is bound to the housing, so as to avoid losing the butterfly screw 18 for mishandling after it is screwed out.

The butterfly screw 18 can be screwed down and screwed out easily for its structural characteristics, so the assembly and disassembly of fixing side cover 14 can be implemented quickly, so as to implement quick assembly and disassembly of plunger pump assembly 3 and housing 1.

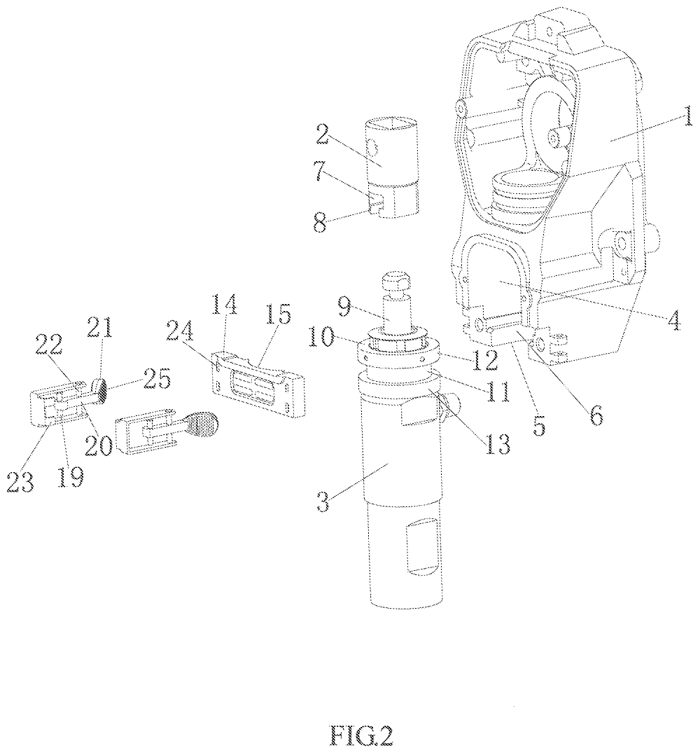

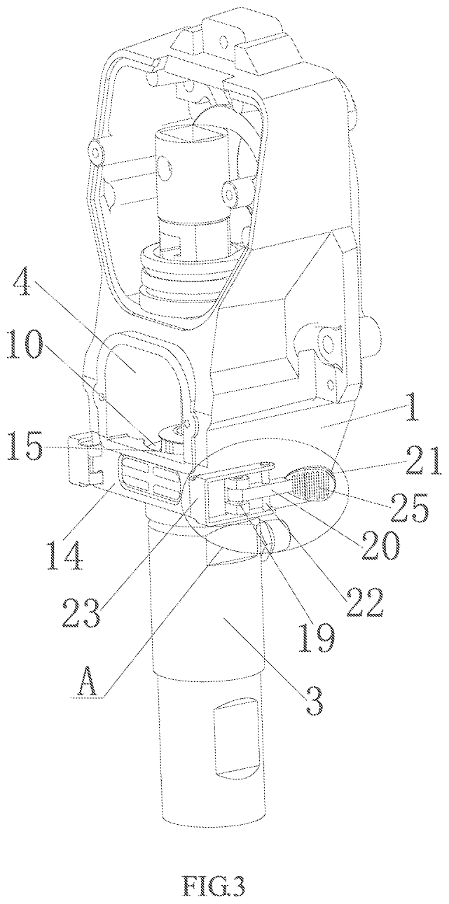

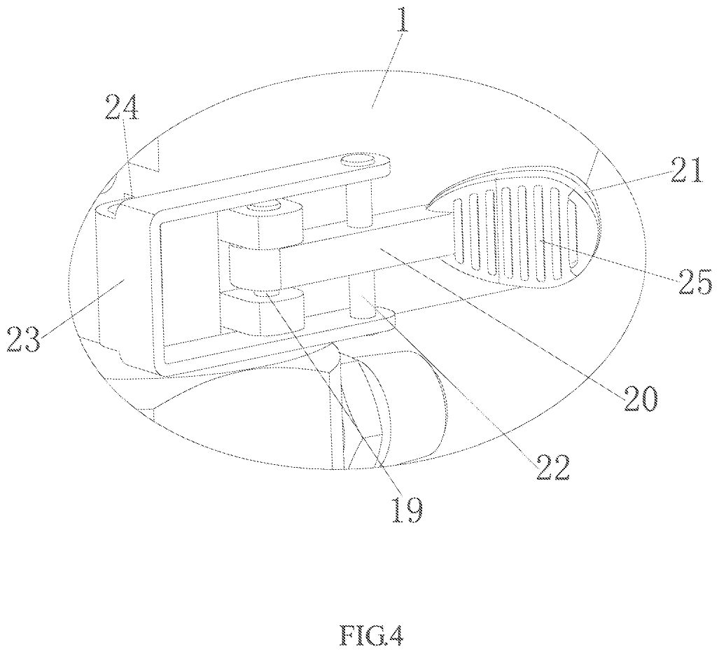

Embodiment 2, please see FIG. 2 to FIG. 4, the fixing devices include the rotating shafts 19 hinging on both sides of the bottom of housing 1. The rotating shaft 19 is connected to pull plate 20. One end of the pull plate 20 is provided with a holding portion 21. The holding portion 21 is connected to a hook 23 via connecting rod 22. The fixing side cover 14 is provided with caulking grooves 24 matching the hook 23.

When the worker dismounts the fixing side cover 14, as long as the holding portion 21 is held, and the pull plate 20 is pulled outwards, the pull plate 20 performs circular motion centered on rotating shaft 19. The hooks of hook 23 are disengaged from the caulking grooves 24 along the trajectory of caulking grooves 24 under the effect of connecting rod 22, so as to dismount the fixing side cover 14. To mount the fixing side cover 14, as long as the pull plate is pressed towards the housing 1 via the holding portion 21, the hooks of hook 23 are inserted into the caulking grooves 24 again, so as to mount the fixing side cover 14. Therefore, the mounting and dismounting of fixing side cover 14 can be completed easily by pulling the holding portion 21.

The external surface of the holding portion 21 is provided with several uniformly distributed anti-slip bulges 25, the anti-slip bulges 25 can increase the friction between holding portion 21 and hand effectively, favorable for applying external force.

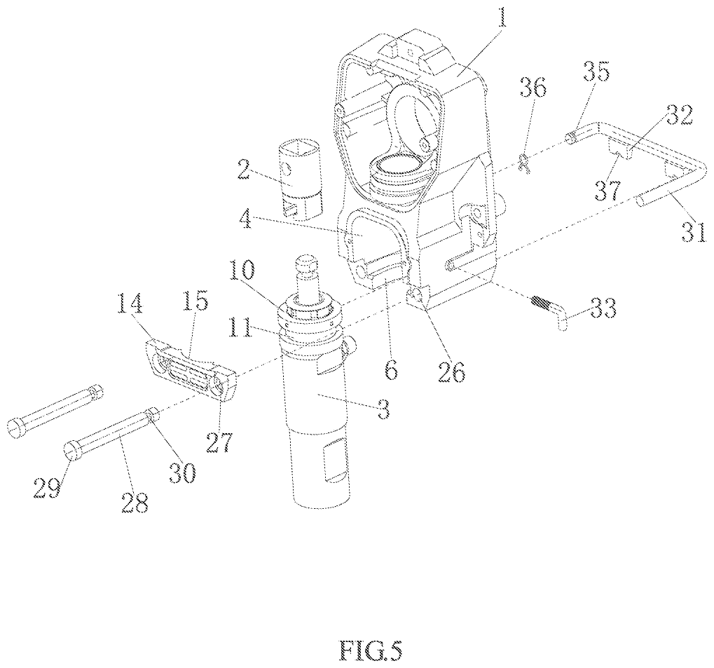

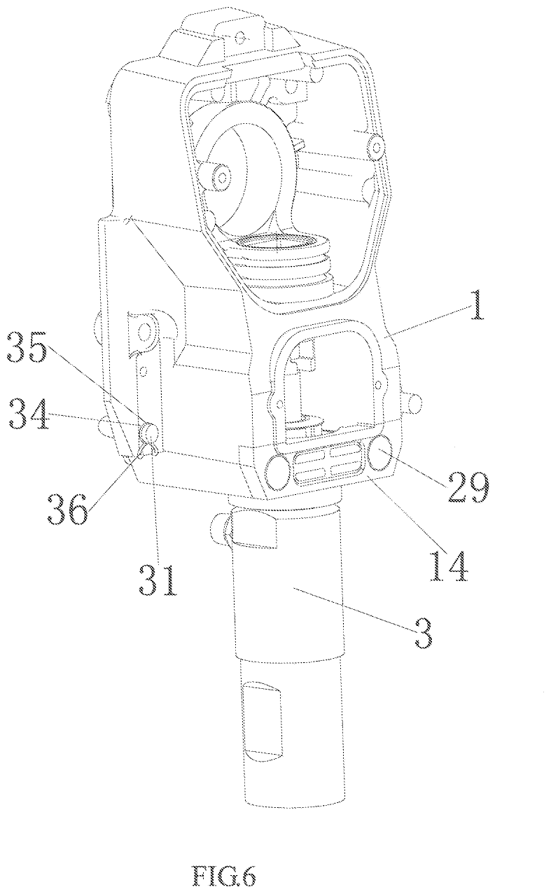

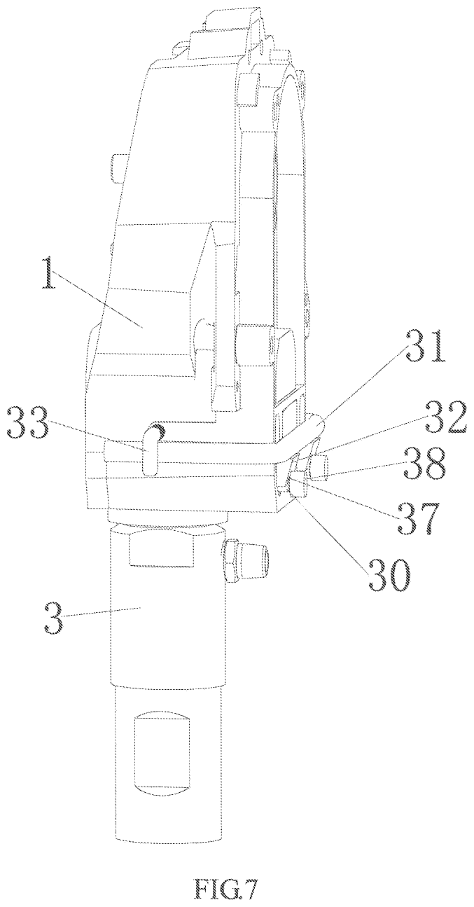

Embodiment 3, please see FIG. 5 to FIG. 7, mutually symmetrical through holes 26 are located in both sides of the bottom of the housing 1. The fixing side cover 14 is provided with limiting holes 27 corresponding to the through holes 26. The fixing devices include the limiting pins 28 located in the through holes 26. One end of the limiting pin 28 penetrates through the limiting hole 27 and it is provided with a limiting head 29 matching the fixing side cover 14. The other end penetrates through the through hole 26 and it is provided with an annular limiting groove 30. The housing 1 is hinged with a U-shaped positioning rod 31. The positioning rod 31 is provided with latching forks 32 matching the limiting grooves 30. An L-shaped bolt 33 corresponding to the free end of positioning rod 31 is screwed in the housing 1.

To dismount the fixing side cover 14, as long as the L-shaped bolt 33 is turned, the L-shaped bolt 33 does not clamp the free end of positioning rod 31 on its lower part anymore, the positioning rod 31 can rotate along the hinge point at the other end, so that the latching forks 32 are disengaged from the limiting grooves 30, the limiting pins 28 are not restrained anymore, the limiting pins 28 are withdrawn from the through holes and limiting holes 27, and then the fixing side cover 14 can be removed from housing 1 easily.

The housing 1 is provided with a hinge hole 34. One end of the positioning rod 31 penetrates through the hinge hole 34 and it is provided with an annular positioning slot 35. The positioning slot 35 is provided with a matching circlip 36. The circlip 36 implements the hinging between positioning rod 31 and housing 1, the positioning rod 31 can be mounted and dismounted quickly, favorable for repairing and changing the positioning rod 31.

One side of the latching fork 32 opposite to the limiting groove 30 is provided with a U-shaped notch 37. The limiting groove 30 forms a pressing end 38 of the limiting pin 28. One side of the latching fork 32 contacting the pressing end 38 is an inclined plane. When the latching fork 32 is chucked in the limiting groove 30, the notch 37 is inserted in the limiting groove 30 directly. As the latching fork 32 presses down, the inclined plane of latching fork 32 presses the pressing end 38 more tightly, and the limiting pin 28 is steadier.

To sum up, the housing can get the plunger pump assembly 3 stuck in the mounting groove 4 directly through the opening of mounting groove 4, and the holding opening 5 enables the plunger pump assembly 3 to move into the mounting groove 4 smoothly from side. When the plunger pump assembly 3 is being chucked in the mounting groove 4, the chucking step 6 penetrates into the annular groove 11 directly, the upper seizing part 12 and lower seizing part 13 confine the up-down movement of plunger pump assembly 3 effectively, and the end of piston rod 9 is stuck in the connecting slot 7 of piston 2. The clamping of the end of piston rod 9 and connecting slot 7 and the clamping of chucking step 6 and annular groove 11 form two longitudinal fixings, so that the plunger pump assembly 3 will never have longitudinal displacement. As long as the fixing side cover 14 confines the lateral movement of plunger pump assembly 3, the plunger pump assembly 3 and housing 1 and be fixed. The fixing side cover 14 is fixed by fixing devices, the fixing devices can be fixed by hand easily.

Therefore, the worker can assemble and disassemble the plunger pump assembly and housing easily, the equipment maintenance and replacement efficiency is increased effectively.

We claim:

1. A reciprocating plunger pump for spray coater which is capable of being assembled and disassembled quickly comprising:
a housing, a piston located in a housing and a plunger pump assembly connected to the piston;
wherein the housing includes a mounting groove disposed therein, a holding opening disposed at a bottom of the mounting groove and communicated with the mounting groove; an inner wall of the mounting groove has a U-shaped latching step; one end of the piston is located in the mounting groove and provided with a connecting slot, and the connecting slot is T-shaped; one side of the connecting slot has an opening; the plunger pump assembly is provided with a piston rod; one end of the piston rod is I-shaped; the end of piston rod is inserted into the connecting slot through the opening; an upper part of the plunger pump assembly is sleeved with a disassembly sleeve; and a middle part of the disassembly sleeve includes an annular groove matching the latching step; the annular groove forms an upper seizing part clinging to an upper surface of latching step and a lower seizing part clinging to the lower surface of latching step in upper and lower parts of disassembly sleeve; an opening of the mounting groove is covered with a fixing side cover; one side of the fixing side cover opposite to the disassembly sleeve is provided with a pressing block matched with the disassembly sleeve; the fixing side cover fixes the plunger pump assembly into the mounting groove by fixing devices.

2. The reciprocating plunger pump for spray coater according to claim 1, wherein the pressing block has an arch bridge shape, the pressing block is provided with a semicircular indent, a bottom of the indent is provided with an auxiliary groove in the shape of an arch bridge.

3. The reciprocating plunger pump for spray coaters according to claim 1, wherein the fixing side cover is provided with symmetrical punch holes on both sides; one side of the housing opposite to the fixing side cover is provided with bolt holes corresponding to the punch holes; the fixing devices are butterfly screws, the butterfly screws penetrate through the punch holes and are screwed in the bolt holes; the fixing side cover is fastened to the housing by butterfly screws.

4. The reciprocating plunger pump for spray coater according to claim 3, wherein a top of the butterfly screw includes mutually symmetrical connecting holes.

5. The reciprocating plunger pump for spray coater according to claim 1, wherein the fixing devices include a rotating shaft hinged on both sides of a bottom of the housing; the rotating shaft is connected to a pull plate; one end of the pull plate is provided with a holding portion; the holding portion is connected with a hook through the connecting rod; the fixing side cover is provided with a caulking groove matched with the hook.

6. The reciprocating plunger pump for spray coater according to claim 5, wherein an outer surface of the holding portion includes a plurality of non-slip bulges uniformly distributed.

7. The reciprocating plunger pump for spray coater according to claim 1, wherein the both sides of the bottom of the housing include mutually symmetrical through holes; the fixing side cover has limiting holes corresponding to the through holes; the fixing devices include the limiting pin in the through hole; one end of the limiting pin passes through the limiting hole and is provided with a limiting head matched with the fixed side cover, and the other end passes through the through hole and is provided with an annular limiting groove; the housing is hinged with a U-shaped positioning rod; the positioning rod is provided with a matching fork matched with the limiting slot; the housing is screwed with an L-shaped bolt corresponding to a free end of the positioning rod.

8. The reciprocating plunger pump for spray coater according to claim 7, wherein the housing includes a hinge hole; one end of the positioning rod passes through the hinge hole and is provided with an annular positioning groove; the positioning groove is mounted with a matching circlip.

9. The reciprocating plunger pump for spray coaters according to claim 7, wherein a side of the latching fork opposite to the limiting slot is provided with a U-shaped notch; the limiting pin forms a pressing end through the limiting slot; one side of the locking fork opposite to the limiting groove is provided with a U-shaped notch; the limiting groove forms a pressing end of the limiting pin; the side of the locking fork that is contacting with the pressing end is an inclined plane.
